(19) United States
(12) Patent Application Publication
(10) Pub. No.: US 2010/0167002 A1
(43) Pub. Date: Jul. 1, 2010

(54) METHOD FOR ENCAPSULATING ENVIRONMENTALLY SENSITIVE DEVICES

(75) Inventors: Xi Chu, Fremont, CA (US); Chyi-Shan Suen, Sunnyvale, CA (US); Robert Jan Visser, Menlo Park, CA (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: Vitex Systems, Inc., San Jose, CA (US)

(21) Appl. No.: 12/345,717

(22) Filed: Dec. 30, 2008

(51) Int. Cl. B32B 1/04; B32B 37/12; B32B 37/02; B32B 37/10; B32B 1/00

(52) U.S. Cl. 428/69; 156/60; 156/160; 156/182; 156/286; 428/76

(57) ABSTRACT

Methods of sealing environmentally sensitive devices and vacuum insulation panels are described. One method includes: providing first and second substrates; placing the environmentally sensitive device between the first and second substrates; sealing the first and second substrates together with an adhesive, the adhesive having an exposed portion; and covering the exposed portion of the adhesive with a barrier layer, or with a barrier stack comprising at least one decoupling layer and at least one barrier layer.

### BACKGROUND OF THE INVENTION

There is a need for versatile visual display devices for electronic products of many different types. Many different display devices are presently being used, including organic light emitting devices (OLEDs), liquid crystal displays (LCDs), light emitting diodes (LEDs), light emitting polymers (LEPs), electronic signage using electrophoretic inks, electroluminescent devices (EDs), and phosphorescent devices. Many of these display devices are environmentally sensitive. Furthermore, other electronic devices, such as microelectronic devices, including integrated circuits, charge coupled devices, metal sensor pads, micro-disk lasers, electrochromic devices, photochromic devices, microelectromechanical systems (MEMS), organic and inorganic photovoltaic devices, thin film batteries, thin film devices with vias, Electro-Optic Polymer Modulators, and the like are also environmentally sensitive. As used herein, the term environmentally sensitive device means devices which are subject to degradation caused by permeation of environmental gases or liquids, such as oxygen and water vapor in the atmosphere or chemicals used in the processing of the electronic product.

As a result, these devices are often fabricated on glass substrates with glass, metal, or ceramic covers on top of the device with the edges sealed with an adhesive. However, it is well-known that the adhesive itself can be permeable to moisture and/or oxygen. Thus, over time, moisture and/or oxygen (or other contaminants) can diffuse through the adhesive and damage the device.

Vacuum insulation panels also need protection from ambient conditions. Vacuum insulation panels utilize the superior insulation properties of a vacuum. The core material provides structure to withstand pressure, but not to transfer heat. The core is encapsulated in a gas impermeable “membrane” barrier envelope, which is then evacuated and sealed to form the vacuum insulated panel or other shape. The panels can include desiccants and/or getter materials to absorb gases and moisture that permeate through the membrane. Multilayer plastic laminates require more desiccant and getter material. The long term performance of the vacuum insulation panels is highly dependent on the performance of the encapsulation material.

Therefore, there is a need to provide a method of sealing an environmentally sensitive device which protects the adhesive from environmental gases and liquids.

### BRIEF DESCRIPTION OF THE DRAWINGS

FIG. 1 shows one embodiment of a device that can be made using the method of the present invention.

FIG. 2 shows another embodiment of a device that can be made using the method of the present invention.

FIG. 3 shows another embodiment of a device that can be made using the method of the present invention.

FIG. 4A shows another embodiment of a device that can be made using the method of the present invention.

FIG. 4B shows another embodiment of a device that can be made using the method of the present invention.

FIG. 5 shows another embodiment of a device that can be made using the method of the present invention.

FIG. 6 shows another embodiment of a device that can be made using the method of the present invention.

FIG. 7 shows another embodiment of a device that can be made using the method of the present invention.

FIG. 8 shows another embodiment of a device that can be made using the method of the present invention.

FIG. 9 shows one embodiment of a vacuum insulation panel that can be made using the method of the present invention.

### DESCRIPTION OF THE INVENTION

The present invention meets that need by providing a method of sealing an environmentally sensitive device. In one embodiment, the method includes: providing first and second substrates; placing the environmentally sensitive device between the first and second substrates; sealing the first and second substrates together with an adhesive, the adhesive having an exposed portion; and covering the exposed portion of the adhesive with a barrier layer, or with a barrier stack comprising at least one decoupling layer and at least one barrier layer.

By adjacent, we mean next to, but not necessarily directly next to. There can be additional layers intervening between the substrate and the barrier stacks, and between the barrier stacks and the environmentally sensitive device.

In another embodiment, the method includes providing first and second substrates; placing a core material between the first and second substrates; forming the first and second substrates into an envelope having an opening on one side; removing the gas from the envelope forming a vacuum; sealing the opening of the envelope with an adhesive, the adhesive having an exposed portion; and covering the exposed portion of the adhesive with a barrier layer, or with a barrier stack comprising at least one decoupling layer and at least one barrier layer.

In another embodiment, the method includes providing a substrate; placing the environmentally sensitive device adjacent to the substrate; covering the substrate and environmentally sensitive device with an adhesive, the adhesive having an exposed portion; and covering the exposed portion of the adhesive with a barrier layer, or with a barrier stack comprising at least one decoupling layer and at least one barrier layer.

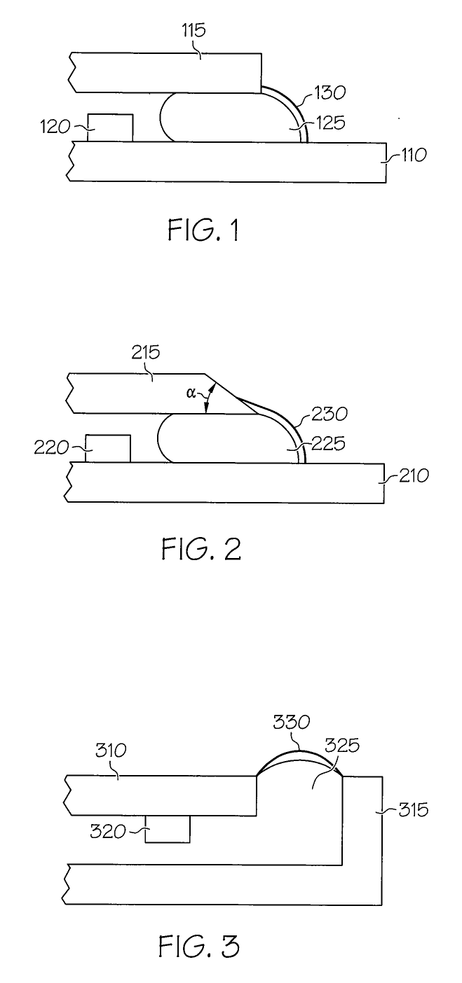

FIG. 1 shows one embodiment of a device that can be made using the method of the present invention. There are first and second substrates 110, 115. The substrates can be any type of substrates useful for the application. They can be either rigid or flexible. The substrates can be transparent, translucent, or opaque, depending on the application. Typically, at least one of the substrates is transparent, and both can be transparent if desired. Suitable substrates include, but are not limited to: metals and metal foils; glass, including thin, flexible, glass sheet (for example, flexible glass sheet available from Corning Inc. under the glass code 0211. This particular thin, flexible glass sheet has a thickness of less than 0.6 mm and will bend at a radium of about 8 inches.); ceramics; semiconductors; silicon; plastic films with barrier coatings; and combinations thereof.

An environmentally sensitive device is placed adjacent to the first substrate 110. The environmentally sensitive device can be any device requiring protection from moisture, gas, or other contaminants. Environmentally sensitive devices include, but are not limited to, organic light emitting devices, liquid crystal displays, displays using electrophoretic inks, light emitting diodes, light emitting polymers, electroluminescent devices, phosphorescent devices, organic and inorganic photovoltaic devices, thin film batteries, and thin film devices with vias, integrated circuits, charge coupled devices, metal sensor pads, micro-disk lasers, electrochromic devices, photochromic devices, microelectromechanical systems (MEMS), Electro-Optic Polymer Modulators, and combinations thereof.

The method can be used to apply either a barrier stack or a single barrier layer over the adhesive. However, for ease of discussion, the method will be described for a barrier stack.

The second substrate 115 is placed adjacent to the environmentally sensitive device 120. The first and second substrates 110, 115 are sealed together with an adhesive 125, sealing the environmentally sensitive device 120 between them. The adhesive 125 extends beyond the second substrate 115, exposing a portion of the adhesive 125 to ambient conditions. The adhesive 125 is then covered with a barrier stack 130. The barrier stack 130 includes at least one decoupling layer and at least one barrier layer.

Although FIG. 1 illustrates the adhesive extending beyond the second substrate, other situations are possible. Protection will be needed whenever the adhesive is exposed to ambient conditions.

The decoupling layer decouples defects between adjacent layers and/or the substrate. The processes used to deposit the barrier layers tend to reproduce any defects in the layer they are deposited on. Therefore, defects in or on the substrate or previous layer may be replicated in the deposited barrier layer, which can seriously limit the barrier performance of the films. The decoupling layer interrupts the propagation of defects from one layer to the next. This is achieved by reducing the surface imperfections of the substrate or previous layer, so that the subsequently deposited barrier layer or other layer, such as the organic light emitting device, has fewer defects. Thus, the decoupling layer has improved surface planarity compared to the previous layer. In addition, the decoupling layers decouple defects in the barrier layers. The decoupling layer intervenes between barrier layers so that the defects in one layer are not next to the defects in the subsequent layer. This creates a tortuous path for gas diffusion, helping to improve the barrier properties. A decoupling layer which is deposited over the barrier layer may also help to protect the barrier layer from damage during processing or further handling.

The decoupling layers can be deposited using a vacuum process, such as flash evaporation with in situ polymerization under vacuum, or plasma deposition and polymerization, or atmospheric processes, such as spin coating, ink jet printing, screen printing, or spraying. The decoupling layer can be made of any suitable decoupling material, including, but not limited to, organic polymers, inorganic polymers, organometallic polymers, hybrid organic/inorganic polymer systems, and combinations thereof. Organic polymers include, but are not limited to, urethanes, polyamides, polyimides, polybutylenes, isobutylene isoprene, polyolefins, epoxies, parylenes, benzocyclobutadiene, polynorbornenes, polyarylethers, polycarbonates, alkyds, polyaniline, ethylene vinyl acetate, ethylene acrylic acid, and combinations thereof. Inorganic polymers include, but are not limited to, silicones, polyphosphazenes, polysilazanes, polycarbosilanes, polycarboranes, carborane siloxanes, polysilanes, phosphonitriles, sulfur nitride polymers, siloxanes, and combinations thereof. Organometallic polymers include, but are not limited to, organometallic polymers of main group metals, transition metals, and lanthanide/actinide metals, or combinations thereof. Hybrid organic/inorganic polymer systems include, but are not limited to, organically modified silicates, preceramic polymers, polyimide-silica hybrids, (meth)acrylate-silica hybrids, polydimethylsiloxane-silica hybrids, and combinations thereof.

The barrier layers can be deposited using a vacuum process, such as sputtering, physical vapor deposition (PVD), chemical vapor deposition (CVD), metalorganic chemical vapor deposition (MOCVD), plasma enhanced chemical vapor deposition (PECVD), atomic layer deposition (ALD), evaporation, sublimation, electron cyclotron resonance-plasma enhanced vapor deposition (ECR-PECVD), and combinations thereof. The barrier layers can be made of any suitable barrier material. Suitable inorganic materials based on metals include, but are not limited to, individual metals, two or more metals as mixtures, inter-metallics or alloys, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxyborides, metal and mixed metal silicides, or combinations thereof. Metals include, but are not limited to, transition (“d” block) metals, lanthanide (“f” block) metals, aluminum, indium, germanium, tin, antimony and bismuth, and combinations thereof. Many of the resultant metal based materials will be conductors or semiconductors. The fluorides and oxides will include dielectrics (insulators), semiconductors and metallic conductors. Non-limiting examples of conductive oxides include aluminum doped zinc oxide, indium tin oxide (ITO), antimony tin oxide, titanium oxides (TiOₓ where 0.8≦x≦1) and tungsten oxides (WOₓ where 2.7≦x<3.0). Suitable inorganic materials based on p block semiconductors and non-metals include, but are not limited to, silicon, silicon compounds, boron, boron compounds, carbon compounds including amorphous carbon and diamond-like carbon, and combinations of. Silicon compounds include, but are not limited to silicon oxides (SiOₓ where 1≦x≦2), polysilicic acids, alkali and alkaline earth silicates, aluminosilicates (AlₓSiO_{y}), silicon nitrides (SNₓH_{y} where 0≦y<1), silicon oxynitrides (SiNₓO_{y}H_{z} where 0≦z<1), silicon carbides (SiCₓH_{y} where 0≦y<1), and silicon aluminum oxynitrides (SIALONs). Boron compounds include, but are not limited to, boron carbides, boron nitrides, boron oxynitrides, boron carbonitrides, and combinations thereof with silicon.

Suitable decoupling layers and barrier layers and methods of making them are described in U.S. Pat. No. 6,268,695, entitled “Environmental Barrier Material For Organic Light Emitting Device And Method Of Making,” issued Jul. 31, 2001; U.S. Pat. No. 6,522,067, entitled “Environmental Barrier Material For Organic Light Emitting Device And Method Of Making,” issued Feb. 18, 2003; U.S. Pat. No. 6,570,325, entitled “Environmental Barrier Material For Organic Light Emitting Device And Method Of Making”, issued May 27, 2003; RE 40531, entitled Ultrabarrier Substrates, issued Oct. 7, 2008; U.S. Pat. No. 6,866,901, entitled Method for Edge Sealing Barrier Films, issued Mar. 15, 2005; U.S. Pat. No. 7,198,832, entitled Method for Edge Sealing Barrier Films, issued Apr. 3, 2007; application Ser. No. 11/068,356, entitled Method for Edge Sealing Barrier Films, filed Feb. 28, 2005; application Ser. No. 11/693,020, entitled Method for Edge Sealing Barrier Films, filed Mar. 29, 2007; and application Ser. No. 11/693,022, entitled Method for Edge Sealing Barrier Films, filed Mar. 29, 2007; each of which is incorporated herein by reference.

The number of barrier stacks is not limited. The number of barrier stacks needed depends on the level of permeation resistance needed for the particular application. One or two barrier stacks may provide sufficient barrier properties for some applications. The most stringent applications may require five or more barrier stacks.

The barrier stacks can have one or more decoupling layers and one or more barrier layers. There could be one decoupling layer and one barrier layer, there could be one or more decoupling layers on one side of one or more barrier layers, there could be one or more decoupling layers on both sides of one or more barrier layers, or there could be one or more barrier layers on both sides of one or more decoupling layers. The important feature is that the barrier stack have at least one decoupling layer and at least one barrier layer. The barrier layers in the barrier stacks can be made of the same material or of a different material, as can the decoupling layers.

In a multilayer stack, the barrier layers are typically about 100 to about 2000 Å thick. The initial barrier layer can be thicker than later barrier layers, if desired. For example, the first barrier layer might be in the range of about 1000 to about 1500 Å, while later barrier layers might be about 400 to about 500 Å. In other situations, the first barrier layer might be thinner than later barrier layers. For example, the first barrier layer might be in the range of about 100 to about 400 Å, while later barrier layers might be about 400 to about 500 Å. In some cases, for example when the barrier layer is deposited by PECVD, even thicker barrier layers are typically used, e.g., up to about 1-2 μm. In some cases, thicker barrier layers cannot be used with flexible substrates. However, with rigid substrates, flexibility of the barrier layer is not required.

The decoupling layers are typically about 0.1 to about 10 μm thick. The first decoupling layer can be thicker than later decoupling layers, if desired. For example, the first decoupling layer might be in the range of about 3 to about 5 μm, while later decoupling layers might be about 0.1 to about 2 μm.

The barrier stacks can have the same or different layers, and the layers can be in the same or different sequences.

The barrier stack can be deposited adjacent to the adhesive using the processes described above. Alternatively, the barrier stack can be deposited on a substrate and laminated adjacent to the adhesive. The barrier stack can be laminated by heating, soldering, using an adhesive, ultrasonic welding, applying pressure, or other known method.

Alternatively, in some situations, a single barrier layer can be used to protect the adhesive. A single barrier layer typically ranges in thickness from abut 100 Å to about 1-2 μm, depending on the process used.

Although the adhesive is shown in the figures as forming a convex shape, this is not necessary. It could form a concave shape, it could be flat, or it could form some other shape, depending on the amount, and type of adhesive, and application method used.

Suitable adhesives for vacuum include, but are not limited to two part systems; e.g., epoxies and urethanes, UV (ultraviolet) or EB (electron beam) curable based on acrylate and/or methacrylate functional precursors, thermoplastic adhesives, often called hot melts or heat activated, and pressure sensitive adhesives. These are typically applied as 100% solid systems that cure via addition mechanisms and so avoid issues associated with volatile reaction byproducts in a vacuum environment. Suitable adhesives can also be applied by routine atmospheric processes; i.e., casting layers from carriers, typically solvents or water that is then removed (dried). The resulting “dried” adhesive can be a pressure sensitive that bonds with contact, a thermoplastic activated by heat when thermally reversible bonding is adequate or a thermoset also activated by heat when irreversible bonding is required; i.e., use in high operating temperature environments. Thermoplastic adhesives can also be applied as fluids at elevated temperatures, cooled (frozen) to a solid state at ambient temperatures and then activated by reheating. Moisture cure (moisture exposure activated) adhesives useful in atmospheric environments include, but are not limited to moisture cure urethanes, RTV silicones and cyanoacrylates. Suitable adhesive application methods include, but are not limited to aforementioned casting, extrusion coating, ink jet printing, transfer (lamination) from a temporary support (release liner), and injection. The last mentioned is useful for more reactive two part systems or highly reactive catalyzed systems, and is designed such that in each component is supplied from separate sources to common mixing chamber just prior to application.

FIG. 2 shows a similar embodiment with the environmentally sensitive device 220 positioned between the first and second substrates 210, 215. The glue 225 is covered with a barrier stack 230. The edge of the second substrate 215 forms an angle a, which is less than 90° (as shown in FIG. 1). The smaller angle allows better coverage of the adhesive during deposition.

FIG. 3 shows another embodiment of a device which can be made using the process of the present invention. In this embodiment, there is an environmentally sensitive device 320 adjacent to the first substrate 310, which is flat. The second substrate 315 is C-shaped. The second substrate is filled with adhesive 325. The adhesive is then covered with the barrier stack 330. Alternatively, the environmentally sensitive device could be adjacent to the C-shaped substrate, which would then be filled with adhesive, and the other substrate adhered to it.

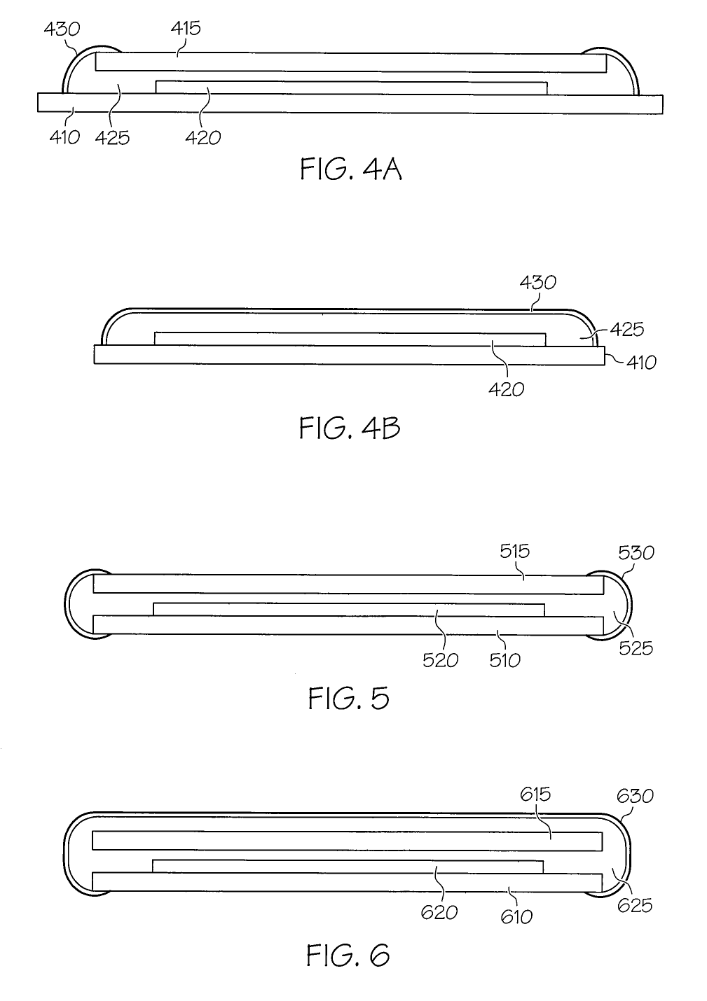

FIG. 4A shows an embodiment in which there are first and second substrates 410, 415, with the second substrate 415 being shorter than the first substrate 410. The environmentally sensitive device 420 is adjacent to the first substrate 410. The adhesive 425 fills the space between the first and second substrates 410, 415, and covers the environmentally sensitive device 420. The edge of the adhesive 425 is exposed beyond the end of the second substrate 415. The barrier stack 430 covers the exposed adhesive at both ends.

FIG. 4B shows an embodiment in which there is a first substrate 410 with an environmentally sensitive device 420 is adjacent to the first substrate 410. The adhesive 425 covers the environmentally sensitive device 420. The upper surface of the adhesive 425 is exposed. The barrier stack 430 covers the exposed adhesive 425. The barrier stack 430 can be applied to adhesive 425 before or after the adhesive is applied to cover the environmentally sensitive device 420. If the barrier stack is applied to the adhesive 425 before the adhesive is applied to the environmentally sensitive device, the adhesive 425 can act as a carrier film for the barrier stack 430).

FIG. 5 shows an embodiment in which the environmentally sensitive device 520 is between flat first and second substrates 510, 515. The first and second substrates 510, 515 are approximately the same length in this embodiment. The adhesive 525 fills the space between the first and second substrates 510, 515, and covers the environmentally sensitive device 520. The adhesive 525 is exposed at both ends of the substrates. The adhesive 525 is covered with a barrier stack 530.

FIG. 6 shows an embodiment in which the environmentally sensitive device 620 is between the first and second substrates 610, 615. The adhesive 625 fills the space between the first and second substrates 610, 615 and covers the top of the second substrate 615. The exposed adhesive 625 is covered with a barrier stack 630 which extends around the ends of the first and second substrates 610, 615 and covers the top of the second substrate 615.

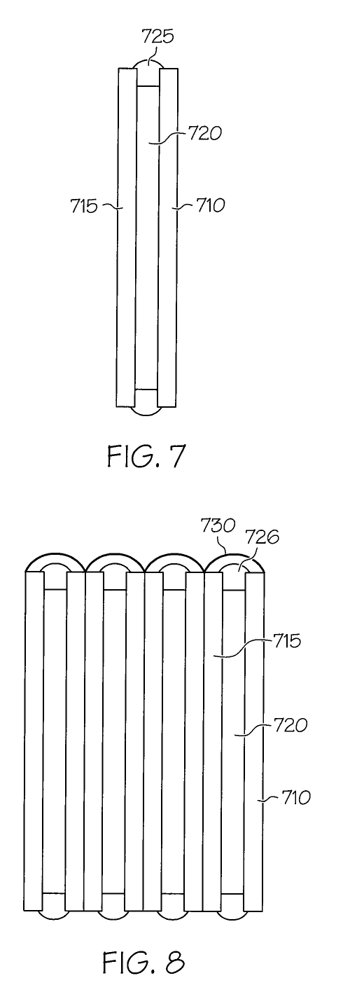

FIGS. 7-8 show an example of an display, such as OLED. The OLED 720 is between flat first and second substrates and sealed with adhesive 725.

Several such units can be assembled into a display. The units can be placed adjacent to one another. The adhesive for all of the units can then be covered with the barrier stack at the same time, as shown in FIG. 8. This would allow tiling of pixels/displays to create bigger displays.

The adhesive used in each of the units can be the same or it can be different, if desired.

The first and second substrates can be a single piece of material folded over, or two separate pieces of material. The single piece of material can be folded over and sealed along two sides (or one side and the bottom). The two separate pieces of material can be sealed along both sides and the bottom. The seal can be formed by heat sealing or by sealing with an adhesive. If an adhesive is used, the adhesive can be covered with a barrier stack, if desired. The adhesive used to seal the opening and the sides can be the same or different, if desired.

When a liquid device, such as a liquid crystal display or an electrophoretic ink, is used in the device, edges of the substrates are sealed leaving a space between them, and an opening is left in the seal. The liquid is introduced into the opening in the seal, and the opening is sealed, producing the device. The substrates can be a single piece of material or two separate pieces, as described above. At least one of the sides is sealed, as described above, and an opening is left in the seal on one of the sides before the liquid is introduced. The opening in the side is then sealed with the adhesive, and the adhesive is covered with the barrier stack, as described above.

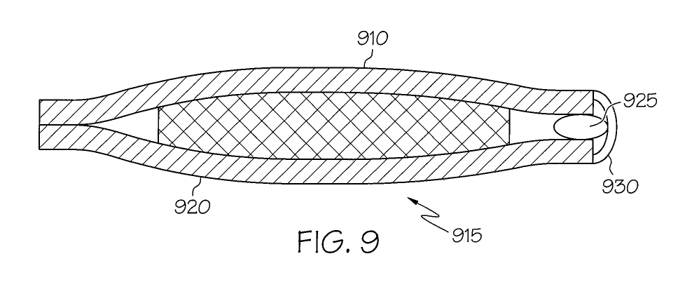

In another embodiment, the invention involves a method of sealing a vacuum insulation panel. As shown in FIG. 9, there are first and second substrates 910, and 915. The first and second substrates 910, 915 form an envelope surrounding the core material 920. The envelope has an opening in one side. The opening can cover part of the side or the whole side. The gas is evacuated from the envelope forming a vacuum, and the opening of the envelope is then sealed with an adhesive 925. The adhesive 925 is covered with a barrier stack 930, as described above.

The envelope can be formed by sealing a single piece of material folded over along two sides (or one side and the bottom), or by sealing two separate pieces of material along both sides and the bottom. The seal used to make the envelope can be formed by heat sealing or by sealing with an adhesive. If the envelope is formed using an adhesive, the adhesive can be covered with a barrier stack, if desired.

Suitable substrates for the vacuum insulation panels include, but are not limited to, polyethylene (PE), polyethylene terephthalate (PET), polyethylene naphthalate (PEN), polyimide (PI), substrates having one or more barrier stacks thereon, or combinations thereof.

The adhesive used to seal the opening in the envelope and that used to form the envelope can be the same or different, if desired.

The barrier layer or the barrier stack can be deposited so that it covers all or part of the surface of one or both substrates, if desired. This will provide additional protection for the vacuum insulation panel.

The envelope can be formed from the substrates before or after the core material is placed between them.

While certain representative embodiments and details have been shown for purposes of illustrating the invention, it will be apparent to those skilled in the art that various changes in the compositions and methods disclosed herein may be made without departing from the scope of the invention, which is defined in the appended claims.

What is claimed is:

1. A method of sealing an environmentally sensitive device comprising:
providing first and second substrates;
placing the environmentally sensitive device between the first and second substrates;
sealing the first and second substrates together with an adhesive, the adhesive having an exposed portion; and
covering the exposed portion of the adhesive with a barrier layer, or with a barrier stack comprising at least one decoupling layer and at least one barrier layer.

2. The method of claim 2 wherein an edge of the first or second substrate has an angle of less than 90°.

3. The method of claim 1 wherein at least one of the first or second substrates is flat.

4. The method of claim 1 wherein at least one of the first or second substrates is C-shaped.

5. The method of claim 5 further comprising filling the at least one C-shaped first or second substrate with adhesive.

6. The method of claim 1 wherein covering the exposed portion of the adhesive with the barrier layer, or with the barrier stack comprises vacuum depositing the barrier layer or the barrier stack adjacent to the adhesive.

7. The method of claim 1 wherein the exposed portion of the adhesive is covered with the barrier stack, and wherein the decoupling layer of the barrier stack is deposited using an atmospheric process.

8. The method of claim 1 wherein covering exposed portion of the adhesive with the barrier layer or the barrier stack comprises depositing the barrier layer or the barrier stack on a flexible substrate, and laminating the flexible substrate with the barrier layer or the barrier stack adjacent to the adhesive.

9. The method of claim 1 further comprising covering the first substrate, or the second substrate, or both with the barrier layer or the barrier stack.

10. The method of claim 1 further comprising:
providing a third substrate;
placing a second environmentally sensitive device adjacent to the first substrate;
placing a fourth substrate adjacent to the second environmentally sensitive device;
sealing the third and fourth substrates together with a second adhesive, the second adhesive having an exposed portion;
placing the second-adhesive-covered third substrate, the second environmentally sensitive device, and the fourth substrate adjacent to the adhesive-covered first substrate, the environmentally sensitive device, and second substrate before covering the adhesive and the second adhesive with the barrier layer or with the barrier stack.

11. The method of claim 1 wherein providing first and second substrates comprises providing a single piece of material and folding the single piece of material over.

12. The method of claim 1 wherein providing first and second substrates comprises providing two separate pieces of material.

13. The method of claim 1 wherein the first and second substrates are sealed on at least one side and wherein there is an opening in one side, and wherein the environmentally sensitive device is placed between the first and second substrates after the first and second substrates are sealed on the at least one side, and wherein the opening in the one side is sealed with the adhesive after the environmentally sensitive device is placed between the first and second substrates.

14. The method of claim 13 wherein the first and second substrates are sealed on the at least one side with a second adhesive, the second adhesive having an exposed portion, and further comprising covering the exposed portion of the second adhesive with a barrier layer, or with a barrier stack comprising at least one decoupling layer and at least one barrier layer.

15. A method of sealing an vacuum insulation panel comprising:
providing first and second substrates;
placing a core material between the first and second substrates;
forming the first and second substrates into an envelope having an opening in one side;
removing the gas from the envelope forming a vacuum;
sealing the opening of the envelope with an adhesive, the adhesive having an exposed portion; and
covering the exposed portion of the adhesive with a barrier layer, or with a barrier stack comprising at least one decoupling layer and at least one barrier layer.

16. The method of claim 15 wherein providing first and second substrates comprises providing a single piece of material and folding the single piece of material over, and wherein the envelope is formed by sealing the single piece of substrate with a second adhesive, the second adhesive having an exposed portion, further comprising covering the exposed portion of the second adhesive with a second barrier layer, or with a second barrier stack comprising at least one decoupling layer and at least one barrier layer.

17. The method of claim 15 wherein providing first and second substrates comprises providing two separate pieces of material, and wherein the envelope is formed by sealing the two pieces of substrate with a second adhesive, the second adhesive having an exposed portion, further comprising covering the exposed portion of the second adhesive with a second barrier layer, or with a second barrier stack comprising at least one decoupling layer and at least one barrier layer.

18. The method of claim 15 wherein the envelope is formed before the core material is placed between the first and second substrates.

19. The method of claim 15 wherein the envelope is formed after the core material is placed between the first and second substrates.

20. The method of claim 15 further comprising covering the first substrate, or the second substrate, or both with the barrier layer or the barrier stack.

21. An encapsulated display device comprising:
a first substrate;
an environmentally sensitive device adjacent to the first substrate;
a second substrate adjacent to the environmentally sensitive device;
an adhesive sealing the first and second substrates together, the environmentally sensitive device sealed between the first and second substrates, the adhesive having an exposed portion; and
a barrier layer, or a barrier stack comprising at least one decoupling layer and at least one barrier layer covering the exposed portion of the adhesive.

22. A vacuum insulation panel comprising:
a core material;
an envelope surrounding the core material, the envelope having an opening in one side;
an adhesive in the opening of the envelope, the adhesive having an exposed portion, wherein the adhesive seals the opening of the envelope; and
a barrier layer, or a barrier stack comprising at least one decoupling layer and at least one barrier layer covering the exposed portion of the adhesive;
wherein the gas is removed from the envelope and wherein the envelope is under a vacuum.

23. A method of sealing an environmentally sensitive device comprising:
providing a substrate;
placing the environmentally sensitive device adjacent to the substrate;
covering the substrate and environmentally sensitive device with an adhesive, the adhesive having an exposed portion; and
covering the exposed portion of the adhesive with a barrier layer, or with a barrier stack comprising at least one decoupling layer and at least one barrier layer.
